(19) United States
(12) Patent Application Publication
(10) Pub. No.: US 2026/0063600 A1
(43) Pub. Date: Mar. 5, 2026

(54) FLAT SPIRAL GAS CHROMATOGRAPHY COLUMN

(71) Applicant: Astrotech Technologies, Inc., Austin, TX (US)

(72) Inventors: Patrick R. Lewis, Albuquerque, NM (US); Eric Wallis, Leander, TX (US); Thomas B. Pickens, III, Austin, TX (US)

(21) Appl. No.: 19/308,828

(22) Filed: Aug. 25, 2025

Related U.S. Application Data
(60) Provisional application No. 63/688,437, filed on Aug. 29, 2024.

(51) Int. Cl. G01N 30/60; G01N 30/02; G01N 30/20; G01N 30/30

(52) U.S. Cl. CPC G01N 30/60; G01N 30/20; G01N 30/30; G01N 2030/025; G01N 2030/207; G01N 2030/6013

(57) ABSTRACT

A flat spiral microfabricated gas chromatography column is formed by etching a spiral channel into a planar substrate and bonding additional substrates to each side thereof. Holes or vias in these substrates form an entrance and an exit to the spiral channel etched in the middle substrate. More than one spiral may be etched into a substrate and more than one entrance and exit may be etched into the top and bottom substrates to provide an entrance and an exit to the spiral channel. The spiral channel may have an etched width that is wider than the substrate is thick. In this fashion, a high aspect ratio column is formed with the channel width defining the long dimension of the high aspect ratio column and the thickness of the substrate defining the short dimension of the high aspect ratio column.

### CROSS-REFERENCE TO RELATED APPLICATIONS

This application claims priority to U.S. Provisional Application No. 63/688,437 filed Aug. 29, 2024, entitled “Flat Spiral Gas Chromatography Column,” the disclosure of which is hereby incorporated by reference in its entirety.

### TECHNICAL FIELD

The present disclosure relates to a gas chromatography column. More particularly, the present disclosure relates to a compact gas chromatography column including a microfabricated spiral channel.

### BACKGROUND

Gas chromatography is used to separate compounds in gas samples for composition analysis. Typically, the gas sample is injected into a column and constituents of the sample separate based on affinity. A longer column can provide better separation and improved accuracy. Past efforts have been made to increase column length while maintaining a small footprint (U.S. Pat. Nos. 6,068,684, 7,273,517, and 8,635,901). However, many of these existing techniques yield undesirable flow dynamics such as inconsistent velocity and turbulence, which can degrade efficiency.

### BRIEF DESCRIPTION OF THE DRAWINGS

Embodiments of the subject matter are disclosed with reference to the accompanying drawings and are for illustrative purposes only. The subject matter is not limited in its application to the details of construction or the arrangement of the components illustrated in the drawings. Like reference numerals are used to indicate like components, unless otherwise indicated.

FIG. 1 is a perspective view of a gas chromatography column according to an embodiment of the present disclosure;

FIG. 2 is a top view of a lid according to an embodiment of the present disclosure;

FIG. 3 is a top view of a channel plate according to an embodiment of the present disclosure;

FIG. 4 is a top view of a lid according to an embodiment of the present disclosure;

FIG. 5 is a top view of a channel plate according to an embodiment of the present disclosure;

FIG. 6 is a top view of a lid with vias according to an embodiment of the present disclosure;

FIG. 7 is a top view of a channel plate according to an embodiment of the present disclosure;

FIG. 7A is a cross-section view of the channel plate of FIG. 7.

FIG. 8 is a top view of a lid with vias according to an embodiment of the present disclosure;

FIG. 9 is a top view of a channel plate according to an embodiment of the present disclosure;

FIG. 9A is a cross-section view of the channel plate of FIG. 9.

FIG. 10 is a top view of a lid according to an embodiment of the present disclosure; and

FIG. 11 is an exploded perspective view of a gas chromatography column according to an embodiment of the present disclosure.

### DETAILED DESCRIPTION

The following descriptions are provided to explain and illustrate embodiments of the present disclosure. The described examples and embodiments should not be construed to limit the present disclosure.

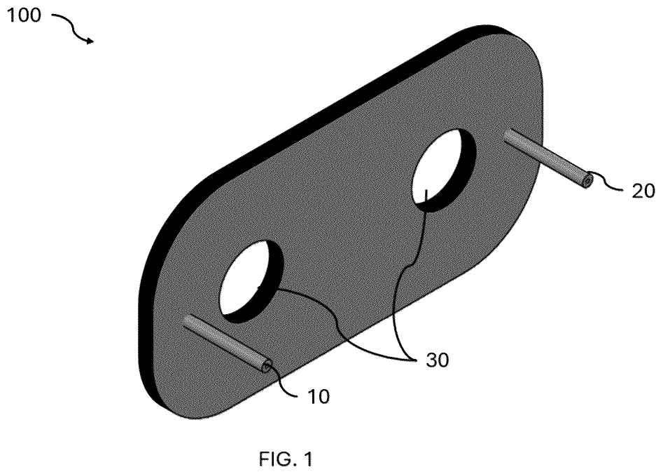

Referring to FIG. 1, a gas chromatography (GC) column 100 is shown. The GC column 100 is a flat spiral microfabricated gas chromatographic column for separation of analytes in a sample gas mixture. The GC column 100 includes a sample input port 10 for introducing a sample gas into the GC column 100 and an exit port 20 for receiving the separated sample gas. The exit port 20 may be in fluid communication with a sample detector, such as a microbalance, a thermal conductivity detector, a chemical impedance detector, or an ionization-based detector. Although the sample input port 10 and the exit port 20 are depicted as being on the same side of the GC column 100, in some embodiments, the sample input port 10 and the exit port 20 may be on opposite sides of the GC column 100.

The GC column 100 may include one or more holes 30 extending through an entire thickness of the GC column 100. The holes 30 reduce the mass of the GC column 100 allowing for more efficient heating and cooling thereof. Although two holes 30 are shown in FIG. 1, the GC column 100 may have a single hole 30 or more than two holes 30. As discussed in more detail below, the GC column 100 includes one or more spiral channels formed in one or more planar channel plates. In some embodiments, the spiral channels are etched through a thickness of the channel plates. In some embodiments, the number of holes 30 is equal to the number of spiral channels in each channel plate of the GC column.

Although not depicted in FIG. 1, the GC column 100 may further include one or more of a heating element, such as a resistive heater, a cooling element, such as a thermoelectric cooler, and/or a temperature sensor in communication with a channel of the GC column 100. In some embodiments, the GC column 100 includes a heating element, a cooling element, and a temperature sensor.

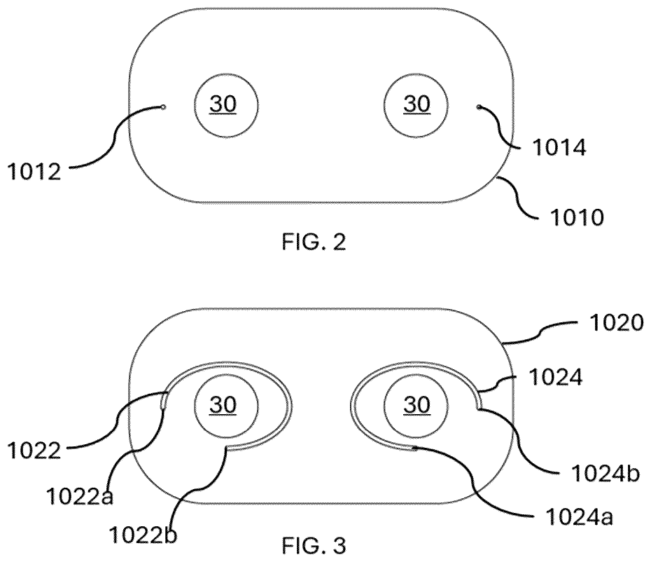

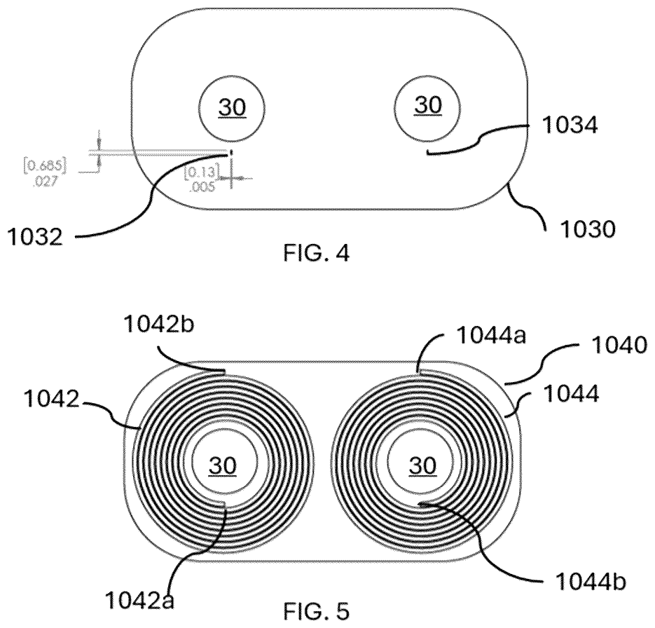

Turning to FIG. 2, a top lid 1010 is depicted including a first via 1012 configured to be in communication with the sample input port 10 and a second via 1014 configured to be in communication with the exit port 20. FIG. 3 depicts a first channel plate 1020 including a first spiral channel 1022 extending from an origin 1022a to a terminal 1022b and a second spiral channel 1024 extending from an origin 1024a to a terminal 1024b. The spiral channels described herein may extend through an entire thickness of their respective channel plates such that a height of the channel is equal to the channel plate thickness. The origin 1022a is in communication with the first via 1012 and the terminal 1024b is in communication with the second via 1014.

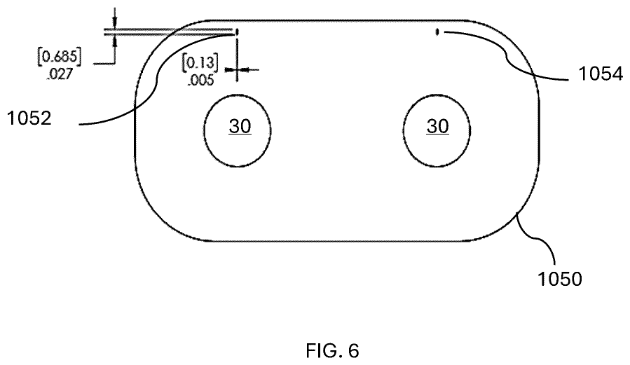

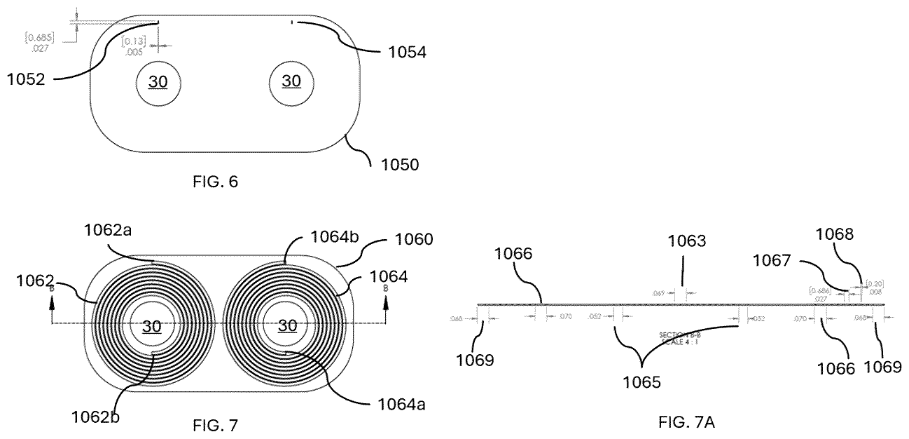

FIG. 4 depicts a second lid 1030 including a third via 1032 in communication with the terminal 1022b and a fourth via 1034 in communication with the origin 1024a. FIG. 5 depicts a second channel plate 1040 including a first spiral channel 1042 extending from an origin 1042a to a terminal 1042b and a second spiral channel 1044 extending from an origin 1044a to a terminal 1044b. The origin 1042a is in communication with the third via 1032 and the terminal 1044b is in communication with the fourth via 1034.

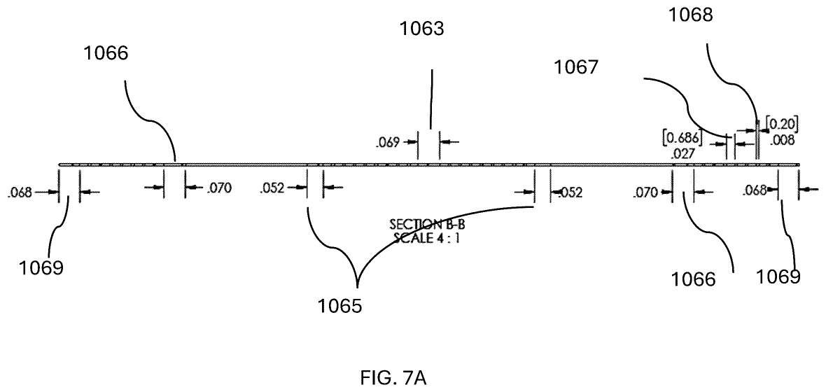

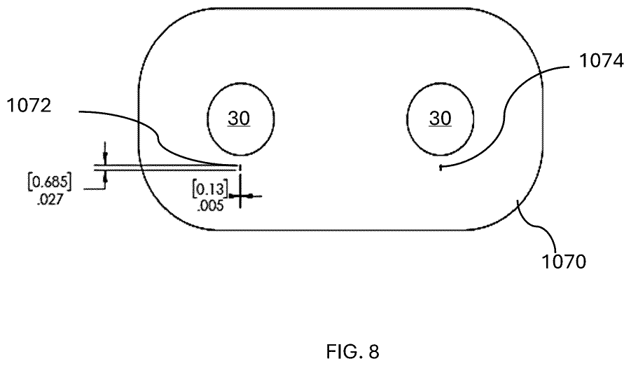

FIG. 6 depicts a third lid 1050 including a fifth via 1052 in communication with the terminal 1042b and a sixth via 1054 in communication with the origin 1044a. FIG. 7 depicts a third channel plate 1060 including a first spiral channel 1062 extending from an origin 1062a to a terminal 1062b and a second spiral channel 1064 extending from an origin 1064a to a terminal 1064b. The origin 1062a is in communication with the fifth via 1052 and the terminal 1064b is in communication with the sixth via 1054. FIG. 7A is a cross-sectional view of the third channel plate 1060. Features shown in FIG. 7A include a spacing 1063 between the spiral channels 1062 and 1064 (e.g., about 0.064 inches), a spacing 1065 between interior edges of the holes 30 and the spiral channels 1062 and 1064 (e.g., about 0.052 inches), a spacing 1066 between exterior edges of the holes 30 and the spiral channels 1062 and 1064 (e.g., about 0.070 inches), a column width 1067 (e.g., about 0.027 inches), a spacing 1068 between adjacent columns (e.g., about 0.008 inches), and a spacing 1069 between the spiral channels 1062 and 1064 and outer edges of the third channel plate 1060 (e.g., about 0.068 inches).

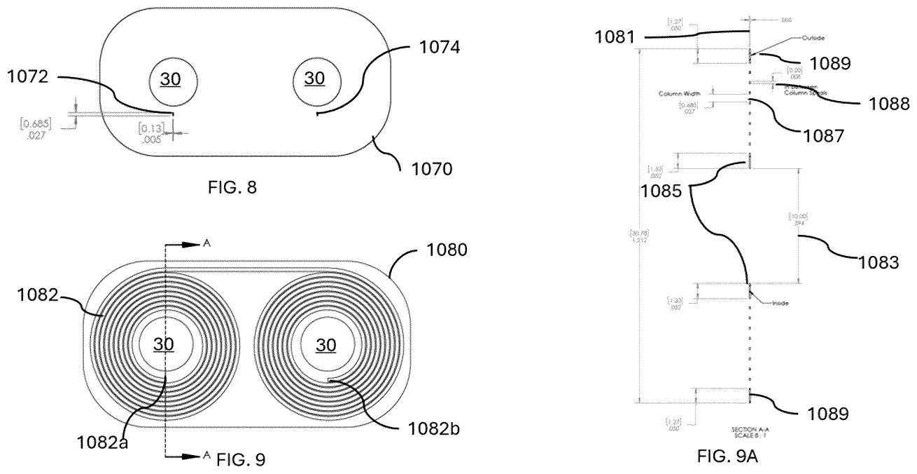

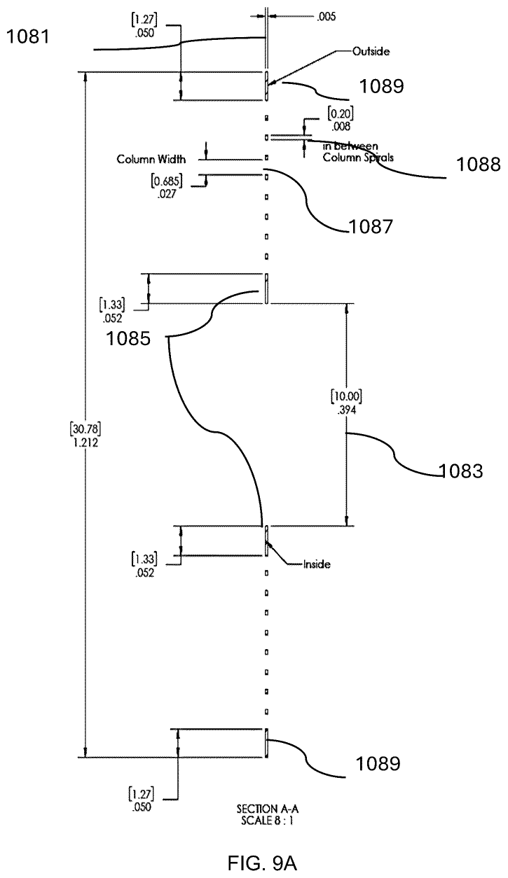

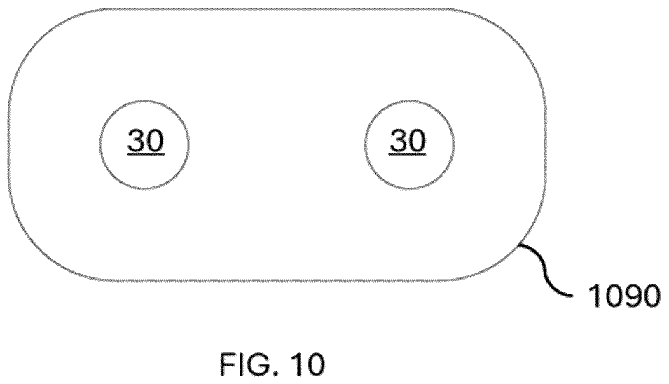

FIG. 8 depicts a fourth lid 1070 including a seventh via 1072 in communication with the terminal 1062b and an eighth via 1074 in communication with the origin 1064a. FIG. 9 depicts a fourth channel plate 1080 including a double spiral channel 1082 extending from an origin 1082a to a terminal 1082b. The origin 1082a is in communication with the seventh via 1072 and the terminal 1082b is in communication with the eighth via 1074. FIG. 9A is a cross-sectional view of the fourth channel plate 1080. Features shown in FIG. 9A include a plate thickness 1081 (e.g., about 0.05 inches), a diameter 1083 of the hole 30 (e.g., about 0.394 inches), a spacing 1085 between interior edges of the holes 30 and the spiral channel 1082 (e.g., about 0.052 inches), a column width 1087 (e.g., about 0.027 inches), a spacing 1088 between adjacent columns (e.g., about 0.008 inches), and a spacing 1089 between the spiral channel 1082 and outer edges of the fourth channel plate 1080 (e.g., about 0.050 inches). FIG. 10 depicts a fifth lid 1090, which does not include any vias.

According to the embodiments depicted in FIGS. 2-10 above, the sample gas flows through one stack of spiral channels (1022, 1042, 1062), through the double spiral channel 1082, and then back up through the other stack of spiral channels (1064, 1044, 1024). In some embodiments, the spiral channels 1022, 1042, 1062 and/or the spiral channels 1024, 1044, 1064 may be replaced with multiple connected spiral channels (e.g., a double spiral channel, a triple spiral channel, a quadruple spiral channel, etc.). In such embodiments, the sample gas flow remains as described above since the spiral channels 1022, 1042, 1062 remain separated from the spiral channels 1024, 1044, 1064. In other embodiments, the GC column 100 may include channel plates with connected spiral channels such that the sample gas flows into one side of the GC column 100 and exits at an opposite side. In some embodiments, the connected spiral channels may be single, double, triple, quadruple, etc. spiral channels.

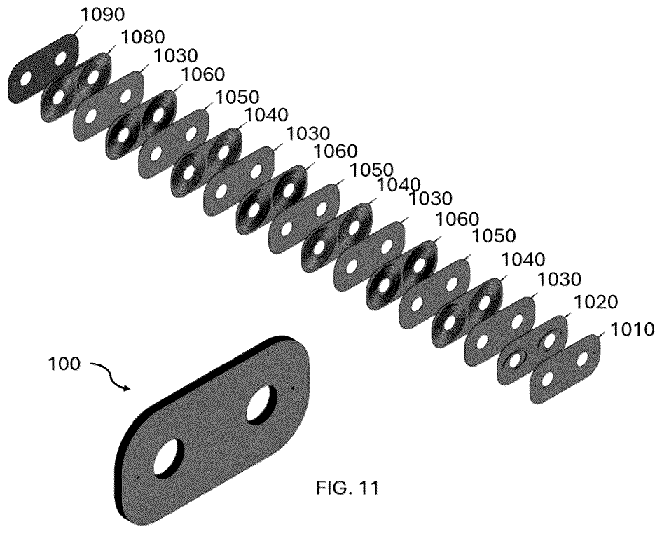

FIG. 11 depicts an example of a GC column 100 according to an embodiment of the present disclosure, wherein the intermediate channel plates (1040, 1060) and lids (1030, 1050) may be repeated any number of times to achieve a desired column length.

In some embodiments, the GC column 100 may include a sample loop. In some embodiments, the sample loop may be integrally formed with the GC column and may include a bypass line (e.g., formed by additional vias). In such embodiments, the sample loop may comprise one or more, two or more, or three or more channel plates as described herein with lids comprising vias for connecting the channel plates to one another and to the remainder of the GC column 100. In some embodiments, the sample loop may be an external component. In any embodiment, the sample loop may have a fixed volume. In some embodiments, the GC column 100 may form a part of a micro-electro-mechanical system (MEMS).

For purposes of this disclosure, the sample gas flows through the respective channels from an origin thereof to a terminal thereof. The sample input port 10 and exit port 20, as well as the terminals and origins, may be readily switched resulting in gas flow in the opposite direction of that described above.

Any of the vias described herein may be shaped and sized to be equal to or larger than the dimensions of the spiral channels. For example, the spiral column width may be about 0.027 inches, the depth (thickness) of each channel plate may be about 0.005 inches to about 0.007 inches or about 0.006 inches, and the vias may be about 0.027 inches by about 0.005 inches. According to some embodiments, the GC column 100 is a high aspect ratio column, wherein the column width (1067, 1087) is larger than the plate thickness. In such embodiments, the column width defines the long dimension, and the plate thickness (or depth) defines the short dimension of the high aspect ratio column. In some embodiments, the aspect ratio is at least 2, at least 3, at least 4, at least 5, from 2 to 10, from 3 to 10, from 3 to 8, from 3 to 6, or from 4 to 6. The channel plates and lids described herein are planar structures and may each be formed of the same material or different materials and may have the same thickness or differing thicknesses.

The spiral channels described herein terminate or originate away from their center thereby leaving a void space, which may be utilized for the holes 30 described herein. This configuration eliminates tight turns as the spiral grows smaller in diameter to avoid band broadening from differences in shear velocity. Tight spiral channels can result in differences in flow within a spiral channel due to a racetrack effect in which the innermost section of the spiral travels faster than the outermost section of the spiral channel due to slight differences in length.

In some embodiments, the direction of flow does not change nor does the flow path wrap around on itself when exiting from a first spiral channel traveling through a via layer to a second spiral channel. For example, the gas flow through the spiral channel 1022 is clockwise and remains clockwise in the adjacent spiral channel 1042. This configuration avoids turbulence inducing hairpin turns present in existing columns. In some embodiments, the direction of flow between spiral channel layers may be reversed. In some embodiments, the spiral channels of adjacent channel plates may be offset. For example, flow through a first spiral channel may rotate inwardly and an outlet thereof may be aligned with an outer edge of a second spiral channel such that the flow is again rotating inwardly in the second spiral channel.

In some embodiments, one or more of the channel plates (1020, 1040, 1060, 1080) are partially etched from a single surface thereof such that the channels (1022, 1024, 1042, 1044, 1062, 1064, 1082) do not extend through an entire thickness of the channel plates (1020, 1040, 1060, 1080). For example, in some embodiments, the channel plates (1020, 1040, 1060, 1080) may be about 0.006 inches thick and the channels (1022, 1024, 1042, 1044, 1062, 1064, 1082) may be about 0.005 inches deep such that the non-etched surface of the channel plates (1020, 1040, 1060, 1080) acts as a lid (1030, 1050, 1070) for an adjacent channel plate (1020, 1040, 1060, 1080). In this regard, each of the partially-etched channel plates (1020, 1040, 1060, 1080) may include vias positioned at an origin (1022a/ 1024a/ 1042a/ 1044a/ 1062a/ 1064a/ 182a) and at a terminal (1022b/ 1024b/ 1042b/ 1044b/ 1062b/ 1064b/ 182b) of the channel (1022, 1024, 1042, 1044, 1062, 1064, 1082) to communicate with a channel (1022, 1024, 1042, 1044, 1062, 1064, 1082) of an adjacent channel plate (1020, 1040, 1060, 1080) without the need for a lid (1030, 1050, 1070) therebetween. As an example, with reference to FIG. 11, the channel plate 1040 may be partially etched from a front surface (closer to lid 1010) with vias at terminal 1042b and origin 1044a, thereby obviating the need for lid 1050. Channel plate 1060 may then be partially etched from the front surface and include vias at terminal 1062b and origin 1064a, thereby obviating the need for lid 1030. The GC column 100 may exclude the lids (1030, 1050, 1070) or may include a combination of partially etched channel plates and fully etched channel plates with lids.

In some embodiments, the partially etched channel plates (1020, 1040, 1060, 1080) are further etched from an opposite side to form a more shallow channel matching that of an adjacent channel plate (1020, 1040, 1060, 1080) (also referred to herein as double etched channel plates). For example, the shallow channel may, e.g., be about 0.001 or about 0.002 inches deep with about 0.001 or about 0.002 inches separating the shallow channel from the deeper channel, which may, e.g., be about 0.003, about 0.004, or 0.005 inches deep. As an example, with reference to FIG. 11, the channel plate 1040 may be partially etched from the front surface with vias at terminal 1042b and origin 1044a and further be partially etched from the back side with a channel matching that of channel plate 1060. Channel plate 1060 may then be partially etched from the front surface and attached to the double etched channel plate 1040 such that the channels 1062 and 1064 are formed by a combination of front surface etching of channel plate 1060 and the back surface etching of channel plate 1040. The GC column 100 may exclude the lids (1030, 1050, 1070) or may include a combination of double etched channel plates, partially etched channel plates, and/or fully etched channel plates with lids.

In some embodiments, etching the channel plates (1020, 1040, 1060, 1080) creates substantially vertical walls and the fully etched channel plates between lids thereby forms a rectangular channel with corners of about 90°. In the partially and double etched channel plates described above, the channels may have rounder corners at the bottom of the etched portion. As such, partially etched channels defined by a partially etched channel and a lid (or a planar surface of an adjacent partially etched channel plate) may have a rectangular shape with two corners of about 90° and two corners with a degree of rounding or curvature. And double etched channels defined by a deep partially etched channel of one channel plate and a shallow partially etched channel of an adjacent channel plate may have a rectangular shape with all four corners having a degree of rounding or curvature. In some cases, the rounded corners may provide improved deposition of a stationary phase within the channels.

In any embodiment, any one or more of the lids (1030, 1050, 1070) may be partially etched, on one or both surfaces, with a spiral channel matching that of an adjacent channel plates (1020, 1040, 1060, 1080). For example, the channel plates (1020, 1040, 1060, 1080) may be fully etched with partially etched lids (1030, 1050, 1070) on one or both sides thereof such that the channels (1022, 1024, 1042, 1044, 1062, 1064, 1082) are defined by (i) the fully etched walls of the channel plate (1020, 1040, 1060, 1080) and partially etched spiral channels of two lids (1030, 1050, 1070) or (ii) the fully etched walls, a partially etched spiral channel of a lid (1030, 1050, 1070), and a planar surface from a lid or a partially etched channel plate. As another example, the channel plates may be partially etched and capped with a partially etched lid such that the channel is defined by the partially etched channel of the channel plate and the partially etched spiral of the lid. It will be appreciated that the aspect ratio referred to herein may be modified for the partially etched or double etched embodiments described above, as the short dimension may be less than a thickness of the channel plate (e.g., a partially etched channel plate with a planar lid, a planar backside of another partially etched channel plate, or a partially etched lid or channel plate backside that is shallower than the non-etched thickness of the partially etched channel plate) or may be greater than a thickness of a channel plate (e.g., a fully etched channel plate between one to two partially etched layers or a partially etched channel plate with a partially etched lid or channel plate backside that is deeper than the non-etched thickness of the partially etched channel plate).

The materials forming the components described herein are not particularly limited and may include stainless steel, silicon, or combinations thereof. The GC column 100 of the present disclosure may reduce or eliminate hairpin turns present in prior technologies. In turn, the GC column 100 may reduce band broadening into chromatographic peaks, thereby improving resolution. Any suitable methods of bonding may be used to secure components of the GC column 100 to one another. All bonds, e.g., between lids and channel plates, may be air tight.

Methods of operating or using the GC column 100 are also provided herein. In some embodiments, operating the GC column 100 includes introducing an analyte into the input port 10 such that it travels down through one or more of the channel 1022, the channel 1042, and the channel 1062 (optionally, through multiple of the channel 1042 and/or the channel 1062), into and through the channel 1082, up through one or more of the channel 1064, the channel 1044, and the channel 1024 (optionally, through multiple of the channel 1044 and/or the channel 1064), and out of the outlet port 20 on the same surface of the GC column 100 as the input port 10. In some embodiments, operating the GC column 100 includes introducing an analyte into the input port 10 such that it travels down through one or more of the channel 1022, the channel 1042, and the channel 1062 (optionally, through multiple of the channel 1042 and/or the channel 1062), and out of the outlet port 20 on a different surface of the GC column 100 as the input port 10. In some embodiments, the method includes an initial step of coating surfaces of the channels with a stationary phase, e.g., by depositing a solid or liquid stationary phase during or before assembly of the GC column 100 or depositing a liquid stationary phase after assembly of the GC column 100. The analyte may be a gas or may be vaporized prior to introduction into the GC column and the analyte may include a carrier gas, such as hydrogen, nitrogen, or an inert gas such as helium or argon. The analyte may include a mixture of elements and/or compositions having different affinities or interactions with the stationary phase of the GC column 100, causing them to elute from the GC column 100 at different rates. As such, the makeup/distribution of the analyte being input into the GC column 100 may differ from that exiting the GC column 100 due to partitioning as the fastest moving elements and/or compositions (lower affinity to the stationary phase) will initially predominate the output composition with slower elements and/or compositions (higher affinity to the stationary phase) following thereafter.

As used herein, the term “about” may include the disclosed values along with ranges encompassing +/−10% of said values. Although the present disclosure has been described with respect to various embodiments and optional features, modification and variation of the embodiments herein disclosed can be foreseen by those of ordinary skill in the art, and such modifications and variations are considered to be within the scope of the present disclosure. It is also to be understood that the above description is intended to be illustrative and not restrictive. For instance, it is noted that the diameter, length, and thickness values described above are illustrative only and can be readily adjusted by one of ordinary skill in the art to fit a wide range of potential GC columns and processes. Many alternative embodiments will be apparent to those of ordinary skill in the art upon reviewing the above description. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the disclosure.

What is claimed is:

1. A gas chromatography column comprising:
a first channel plate comprising a spiral channel etched through a thickness thereof, the spiral channel extending from an origin to a terminal;
a first lid bonded to a first side of the first channel plate; and
a second lid bonded to a second side of the first channel plate opposite the first side of the first channel plate; and
wherein the first lid or the second lid comprises a first via aligned with the origin of the spiral channel and the first lid or the second lid comprises a second via aligned with the terminal of the spiral channel.

2. The gas chromatography column of claim 1, wherein the spiral channel has a width greater than the thickness of the first channel plate.

3. The gas chromatography column of claim 1, wherein the first channel plate, the first lid, and the second lid each comprise a hole located within and separated from the spiral channel.

4. The gas chromatography column of claim 1, wherein the first channel plate comprises two connected spiral channels extending from the origin to the terminal.

5. The gas chromatography column of claim 4, wherein the second lid comprises the first via and the second via; and
further comprising:
a second channel plate bonded to the second lid opposite the first channel plate, the second channel plate comprising a first spiral channel etched through a thickness thereof and a second spiral channel etched through a thickness thereof; and
a third lid bonded to the second channel plate opposite the second lid and comprising a third via and a fourth via;
wherein the first spiral channel and the second spiral channel are discrete;
wherein the first spiral channel extends from a first origin to a first terminal and the second spiral channel extends from a second origin to a second terminal;
wherein the third via of the third lid is aligned with the first origin of the first spiral channel and the first via of the second lid is aligned with the first terminal of the first spiral channel; and
wherein the second via of the second lid is aligned with the second origin of the second spiral channel and the fourth via of the third lid is aligned with the second terminal of the second spiral channel.

6. The gas chromatography column of claim 4, wherein the first lid comprises the first via and the second lid comprises the second via; and
further comprising:
a second channel plate bonded to the second lid opposite the first channel plate, the second channel plate comprising two connected spiral channels etched through a thickness thereof and extending from a second origin to a second terminal; and
a third lid bonded to the second channel plate opposite the second lid and comprising a third via; and
wherein second via of the second lid is aligned with the second origin and the third via of the third lid is aligned with the second terminal.

7. The gas chromatography column of claim 4, wherein the first channel plate, the first lid, and the second lid each comprise two holes located respectively within the two connected spiral channels, each of said holes being separated from the two connected spiral channels.

8. The gas chromatography column of claim 4, wherein two connected spiral channels spiral in the same clockwise or counterclockwise direction.

9. The gas chromatography column of claim 4, wherein one of the two connected spiral channels spirals in a clockwise direction and the other of the two connected spiral channels spirals in a counterclockwise direction.

10. The gas chromatography column of claim 1, further comprising a second channel plate bonded to the second lid opposite the first channel plate, the second channel plate comprising a second spiral channel etched through a thickness thereof, the second spiral channel extending from a second origin to a second terminal; and
a third lid bonded to the second channel plate opposite the second lid, the third lid comprising a third via; and
wherein the first lid comprises the first via, the second lid comprises the second via, the second via of the second lid is aligned with the second origin of the second spiral channel, and the third via of the third lid is aligned with the second terminal of the second spiral channel.

11. The gas chromatography column of claim 1, further comprising a sample input port and a sample detector port in fluid communication with the spiral channel.

12. The gas chromatography column of claim 11, wherein the first via or the second via is in communication with the sample input port or the sample detector port.

13. The gas chromatography column of claim 11, wherein the sample input port and the sample detector port are positioned on opposite sides of the gas chromatography column.

14. The gas chromatography column of claim 11, wherein the sample input port and the sample detector port are positioned on the same side of the gas chromatography column.

15. The gas chromatography column of claim 1, further comprising a heating element, a cooling element, a temperature sensor, or combinations thereof.

16. The gas chromatography column of claim 1, further comprising a fixed volume gas sample loop in communication with the first via or the second via, the gas sample loop comprising three or more channel plates.

17. A method of operating the gas chromatography column of claim 1 comprising:
introducing an analyte into an inlet of the gas chromatography column such that the analyte traverses from the origin of the spiral channel to the terminal of the spiral channel; and
receiving the analyte from an outlet of the gas chromatography column.

18. A gas chromatography column comprising:
a first channel plate comprising a spiral channel etched from a first surface through a partial thickness of the first channel plate, the spiral channel extending from an origin to a terminal; and
a lid bonded to the first surface of the first channel plate; and
wherein the lid comprises a first via aligned with the origin of the spiral channel and the first channel plate comprises a second via at the terminal of the spiral channel.

19. The gas chromatography column of claim 18, wherein a first surface of the lid is bonded to the first surface of the first channel plate;
wherein the first surface of the lid comprises a second spiral channel etched through a partial thickness of the lid; and
wherein the second spiral channel is shaped to align with the spiral channel.

20. The gas chromatography column of claim 18, further comprising:
a second channel plate comprising a second spiral channel etched from a first surface through a partial thickness of the second channel plate;
wherein the first surface of the second channel plate is bonded to a second surface of the first channel plate opposite the first surface of the first channel plate;
wherein the second surface of the first channel plate comprises a third spiral channel etched through a second partial thickness of the first channel plate and shaped to align with the second spiral channel; and
wherein a sum of the partial thickness and the second partial thickness of the first channel plate is less than a thickness of the first channel plate.
